(19) United States
(12) Patent Application Publication
(10) Pub. No.: US 2007/0124035 A1
(43) Pub. Date: May 31, 2007

(54) Fully automatic traffic system

(76) Inventor: Peter Hasenfuss, Kreuzlingen (CH)

Correspondence Address: JORDAN AND HAMBURG LLP, 122 EAST 42ND STREET, SUITE 4000, NEW YORK, NY, 10168, US

(21) Appl. No.: 10/574,374

(22) PCT Filed: Sep. 30, 2004
(86) PCT No.: PCT/DE04/02188

§ 371 Date: Oct. 18, 2006

(30) Foreign Application Priority Data
Oct. 2, 2003 (DE) 103 46 188.4

(51) Int. Cl. G05D 1/00; G06F 19/00

(52) U.S. Cl. 701/19; 701/117

(57) ABSTRACT

A fully automatic traffic system includes insertable individual system vehicles that are used for transporting persons and goods, are provided with their own drive system, their own steering mechanism, and at least one power take-off and guiding apparatus, and move along a route which encompasses a solid ground forming the running surfaces for the wheels of the individual vehicles, and a power supply and guiding system over which the wheels of the individual vehicles can roll. At least one power take-off and guiding apparatus of the individual vehicles can be deployed into and retracted from the effective range of the power supply and guiding system of the route. The ground that support the running surfaces for the wheels of the individual vehicles consists of roadway elements which can be separately arranged and/or laid.

The invention starts out from a traffic system of the type given in the main claim. Previously, in order to transport persons or goods, systems such as passenger cars, buses, trucks or rail-based vehicles were used. These systems basically make limitations necessary, either with respect to the individuality or with respect to the energy requirement for making a high transporting capacity available. For example, passenger cars, although they make highly individualized transport of persons possible, cannot drive in closed formation at a short distance behind one another in order to reduce air resistance, as is the case inherently with rail-based vehicles. However, rail-based vehicles, buses and trucks, in particular, have the disadvantage that they are not compatible with one another and do not permit individual transport and interlocking transport systems to be combined for movement at, as far as possible, a uniform speed.

Combinations of the two transporting systems, that is, those which move individually steered vehicles on flat surfaces and rail-based vehicles, have already been realized for special tasks, such as for the transport of raw materials or parts in production buildings or for the transport of persons between, for example, airports and parking stations. Until now, however, these combination systems do not yet permit an individual vehicle to be incorporated at random in a convoy and, after having covered a certain distance with the convoy, to be severed from the convoy so that it may then be steered towards the particular objective. Such combination systems generally are based on street-based vehicles or vehicles, which can be used on streets by way of a steering intervention, which, similar to a toy race track, can be activated over a lever mechanism over rollers from a rail, which specifies the course of the route. However, all of these systems have the disadvantage that, on the one hand, an individual coupling and uncoupling from the guidance by or the connection to an existing convoy in connection with an individual transporting task is not possible and, on the other, that branches and bypasses can be realized only at great structural explains, especially for the configuration of the rails.

Concepts for the transport of persons are known (DE 196 23 244 A1), for which automatically steered vehicles roll on a concrete transmission route. The tracking on the transmission route is realized for these vehicles by means of a guiding system, which encloses the concrete transmission route. It is a disadvantage of this method that an individual uncoupling and coupling is possible only at an increased constructive expense for overcoming the bilateral guiding system of the concrete transmission route. In this connection, it must be taken into consideration especially that, for example, it is difficult to incorporate latching and unlatching points accurately in concrete parts and that a two-dimensional sealing of the underground takes place due to the use of a closed concrete transmission route.

A ground transporter system with contactless inductive transfer of energy (DE 199 55 042 A1) is known, for which the automatically driving vehicles are guided over a slot in the ground. However, this slot has no functions other than the guiding. For transferring energy to the vehicle, current-carrying stranded wires are provided on either side of the slot and transfer electromagnetic induction energy to the vehicle. It is a particular disadvantage of this method that, especially in the case of long routes, large amounts of energy are lost during the generation of an unsteady, alternating electromagnetic field along the induction stranded wires because of the inductive transfer of energy, since, in the final analysis, energy can be withdrawn from the local electromagnetic field only at the place at which the vehicle happens to be.

An automatic, autonomously guided transporting vehicle is also known (DE 41 27 298 A1), which moves with fully automatic steering on a flat roadway. The energy is supplied to this vehicle over an overhead line. As a result, the additional costs, which arise when the roadway is built up and extended, are very high. Moreover, this overhead line interferes when transported goods are loaded and unloaded, since it represents a major source of danger for the operating personnel especially when lifting by means of a forklift truck, crane or the like. Safety in the event of a failure of the automatic steering has proven to be particularly disadvantageous for this type of construction, since the vehicle continues to move on a flat surface and, accordingly, could roll or drive further in any direction if the steering fails.

Moreover, a method for the automatic, driverless operation of vehicles is known (DE 33 15 051 C2), which makes use of a steering system in a transporting vehicle, which stores all control commands, which are entered manually in a first trip, in order to then carry out identical trips automatically. For this method, redundancy in the event of a failure of the steering is not taken into consideration nor is the transporting vehicle provided with energy from the outside, for example, along a rail.

A different, known technique for driverless transporting vehicles make use of a guiding rail (DE 296 05 816 U1), which is engaged, for steering purposes, by a vertically downwardly directed bolt, which is mounted at the transporting vehicle. For supplying electrical energy, a current-conducting contact, which extends along the rail, is mounted on either side of the vehicle. Depending upon their arrangement, the contacts can be tapped horizontally or vertically from the vehicle by a sliding contact.

A different type of known technology (DE 44 31516 A 1) attempts to make it possible to utilize the rail by individual traffic by means of a hybrid wheel, which has bearing surfaces for railroad rails as well as tires for streets. By means of entry ramps, the individual vehicles can be placed automatically on the rails here, which can thus be used as a detour. It is a disadvantage of this technology that coupling between individual vehicles is not possible and accordingly a safety distance must be maintained in order to avoid serious accidents. It has proven to be particularly disadvantageous that, due to the configuration of the vehicle wheels as hybrid wheels, an unnecessarily high unsprung mass results, especially in street operation, which demonstrably contributes extremely disadvantageously to the driving comfort of the respective vehicle.

Automatic transporting systems, especially for commuter traffic on heavily traveled roads, are known. They are guided by a rail, placed above the rolling plane of the wheels and travel on a flat, concrete transmission route or on bridges on rubber tires. The configuration of branches in the sense of switch points is a disadvantage of these systems, since this can be realized only at a high structural cost because of the guiding rail, which is placed above the road surface.

The so-called cable railway is a different type of shuttle for people, for which a wire rope is passed in a centrally disposed channel between the rails along the roadway. The actual vehicle is clamped permanently or clamped by a gripper to the wire rope. Such systems have high frictional losses, especially on a curved roadway, since the cable then contacts over a large area. Moreover, the maintenance costs of such systems are appreciable and are caused mainly by checking the cable for damage.

Finally, systems, for which the vehicle is guided completely in the gulley, are also known. Admittedly, for these systems, convenient entry into and exit is possible, however with the disadvantage that, when air-cushion vehicles are used, an unnecessarily high two-dimensional sealing takes place in this groove.

The Invention and its Advantages

Compared to the preceding, the inventive traffic system with the characterizing distinguishing features of the main claim has the advantage that it can be operated without expensive infiltrating and exfiltrating devices with the systems own (public) vehicles as well as with infiltratable individual vehicles for conveying persons or goods.

The inventive traffic system is operated completely automatically over at least one steering intervention per vehicle. The steering intervention is constructed as an energy-tapping and guiding device, which can be swung in and out, and is in operative connection with a n energy-supplying and guiding system, over which the vehicle is supplied with energy and can be rolled over at least in the region of entry and exit places and crossings or branches or is disposed in the transmission route either between the wheels or at the side next to the vehicle. Owing to the fact that the bearing surfaces for the wheels consists of roadway elements, which can be disposed and/or laid separately, the transmission route can be configured very flexibly. Of course, the inventive traffic system can also be incorporated in existing roadways. For this purpose, the energy supplying system and guiding system need only be inserted in a groove provided in a roadway or an energy supplying system and guiding system, which can be rolled over, need only be fixed in a groove produced in the roadway. For safety reasons, the individual vehicles are subjected to an automatic safety diagnosis before they enter the transmission route of the fully automatic traffic system.

The entrance or exit places to and from such a transmission route are flat panels, for example, concrete panels, in which guide rails are incorporated. The transmission route itself consists essentially of two separate driving bridges, which are mounted either directly on the ground, on a bottom plate or, in the case of an elevated railroad construction, on transverse girders. The transmission route can also be placed underground.

A particular advantage of the fully automatic traffic system also consists therein that branches may be constructed as passive switches, that is, without mechanically moved parts. The selection of the direction at a branch is specified from the vehicle over the energy take-off and guiding device.

Due to the arrangement of the energy supplying and guiding system, which can be rolled over, branches, crossings and entrance and exit places can be realized very easily. In an advantageous development of the invention, the roadway elements are constructed simply as flat panels, in which channels for the energy supplying and guiding system are provided. In variation, which is different in this respect, the energy supplying and guiding system may also be integral components of these panels. By means of the energy supplying and guiding system, which is directly on or below the plane of the roadway, the problem of supplying energy by the overhead lines, which, on the one hand, are expensive to produce and maintain and, on the other, represent an appreciable source of danger when loading and unloading goods, for example, with cranes, is avoided, as is the danger from electric power carrying energy supplying and guiding systems placed above the roadway, which arises, for example, when stepping on the transmission route for inspection purposes or for maintenance work.

The energy supplying system and guiding system has at least one electric current-carrying pole, which, for supplying energy to the vehicles, is tapped by the energy take-off and guiding system with a wiping or rolling contact. One possible embodiment of the guiding system consists of a channel, which is closed in the downward direction, in order to place the guiding rail directly, for example, during the manufacture of a concrete part, in sheathing in order to manufacture integral components. A second possible embodiment of the guiding system consists of a construction, which is divided into two parts in the longitudinal direction, so that, for example, in the case of an overhead railroad construction of the transition route, dirt, which falls into the guiding slot, can fall out of the slot once again downward through a slot, which remains between the two parts forming the guiding rail.

In an advantageous embodiment of the invention, which is different with respect to the energy supplying and guiding system, the latter is placed as a flat tape, over which vehicles can readily roll, on or directly below the surface of the transmission route, which is then, however, closed once again. For this variation, there is no mechanical intervention by the energy take-off and guiding system. Instead, the energy is transferred and the vehicle guided without contact, for example, by electromagnetic means.

The vehicles have normal street tires so that, in particular, the individual vehicles can drive on the transmission routes of the inventive traffic system as well as on normal streets. For this purpose, the energy take-off and guiding device of the individual vehicles can be swiveled into the operating range of the energy supplying and guiding system of the transmission route. In addition, the vehicles are equipped with an energy storage system, by means of which especially the energy, required for trips between, for example, the residence and the entrance to the transmission route, is covered. For example, fuel cell vehicles, which have only relatively small fuel cell units in view of the energy supplied especially for long distance trips, can also make use of the inventive traffic system, since the units have to be designed only for relatively short distances between the entrance places and exit places of the transmission route and the starting place and the destination respectively. By these means, the inventive traffic system contributes to reducing the weight of the individual vehicles and thus enables additional energy to be saved. Hybrid vehicles with different driving systems are also suitable as individual vehicles for the fully automatic traffic system.

In a further, advantageous development of the invention, the driving bridges, that is, the substrate carrying the bearing surfaces of the wheels of the individual vehicles, may be constructed concavely in cross section. This may contribute to improved guidance of the wheels of the vehicle. Aside from infiltrations and exfiltrations, branches and crossings, this concave cross-section can be expanded to a groove-shaped cross section. In this case, the driving bridges have beads, which are drawn up in their edge regions, so that driving noise, resulting from the rolling of the wheels of the vehicle, is broadcast upward by the bead in the direction of the wheel well of a vehicle driving on the transmission route. In order to reduce sound emission, the wheel wells of the vehicles are lined with a sound-absorbing insulating material so that the rolling noise, broadcast upward from the roadway, is dampened and reflected once again in the direction of the surface of the driving bridge.

In a further development of the invention, it is, however, also possible to line the inside of the beads with a sound-absorbing insulating material. For this purpose, it is conceivable to configure the beads, which are the outer beads with respect to the wheels of the vehicles, higher than the beads, which face the inside of the wheels of the vehicle. This measure alone contributes to reducing the sideways broadcasting of sound.

In a further advantageous development of the invention, the bearing surfaces of the wheels of the vehicle are provided with a wear-resistant covering. In this regard, a variation, in which the wear-resistant covering is mounted exchangeably on the bearing surface, proves to be advantageous. Worn places of the covering can then be exchanged easily. The expensive trimming of the roadway will then no longer be required. Furthermore, in contrast to the bearing substrate of the roadway, the different stresses on the bearing surface of the tires can then be taken into account and materials, often optimum for both parts with respect to price and service life, can be selected.

In a further, advantageous development of the invention, the traffic system can be realized very advantageously as an elevated transmission routes. For this purpose, supports are anchored in the ground along the transmission route and transverse beams fastened to their free end. The roadway elements with the bearing surfaces are then placed on these.

According to a particularly advantageous development of the invention, control commands for the individual vehicle are transmitted in addition to the energy supplied by the energy supplying and guiding system and the energy take-off device and guiding device engaging the latter.

Pursuant to different advantageous development of the invention, the transmission of information, such as TV, radio or Internet over the guide rail, in addition to the control commands, becomes possible and, moreover, communications services may also be integrated.

A further advantageous development of the invention permits individual vehicles to drive in a convoy. For this purpose, the individual vehicles are equipped with a controlling and regulating system, which enables then to drive one behind the other at a constant, close distance. The arrangement of the vehicles in the convoy, which is more advantageous from an air flow point of view, has the advantage that less energy is required for the forward movement then would be consumed by the individual vehicles in individual operation. A convoy may consist of passenger cars as well as of trucks. In a development of the invention, which is advantageous in this regard, goods containers without their own driving system, are disposed between two individual vehicles.

For the inventive traffic system, it is to be regarded as particularly advantageous that the requirement for electrical energy is not restricted to one place and, instead, extends especially along a long distance connecting route over a wide area along such a transmission route. Supplementary to the inventive transporting system, installations for the decentralized supplying of traffic routes with electrical energy from renewable sources, such as, for example, wind turbine generator systems or the like, can be set up along the transmission route in addition to the inventive transporting system.

Moreover, because energy is supplied on an electrical basis, the inventive traffic system permits energy, which is released, for example, during braking processes, to be supplied back to the network. This energy becomes available to other vehicles on the transmission route. For example, vehicles, moving downhill, can make available the work of deceleration, which occurs as lost heat in the case of conventional traffic systems, to vehicles moving uphill by way of the transfer of electrical energy.

Further advantages and advantageous developments of the invention may be inferred from the description of the examples, the drawing and the claims.

### DRAWING

Two examples of the inventive traffic system are described in greater detail in the following and shown in simplified fashion in the drawing, in which

FIG. 1 shows a cross-section through a four-track transmission route, which is used on all tracks, as a first example and

FIG. 2 shows a mixed vehicle convoy in side view as a second example.

### DESCRIPTION OF THE EXAMPLE

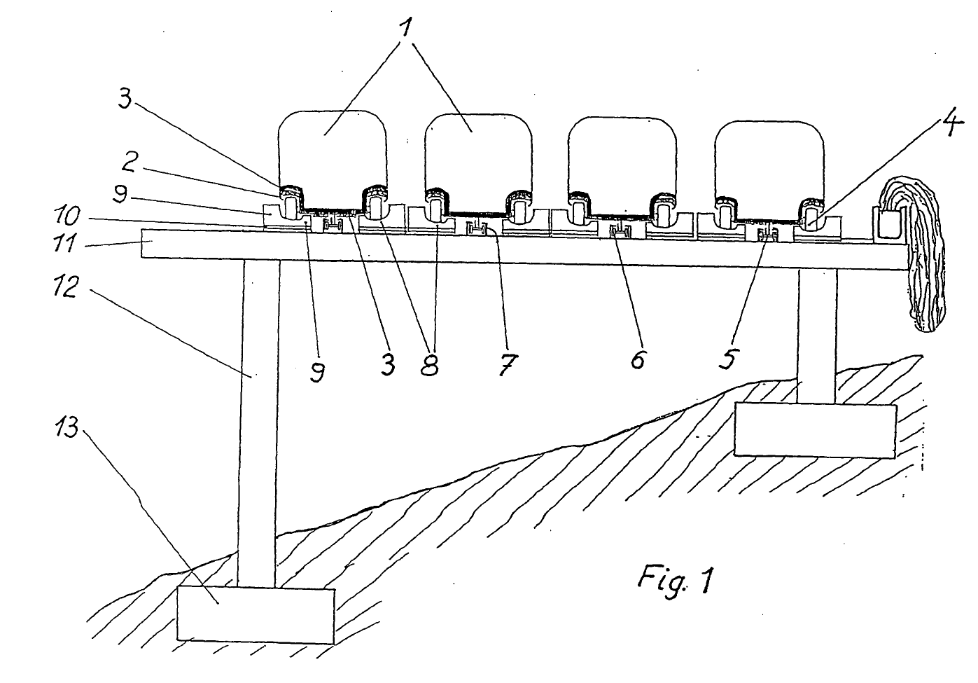

In FIG. 1, vehicles 1 are shown, the underbodies of which, especially in the wheel wells 2, are lined with a sound-absorbing material 3. The vehicles 1 have tires 4, which are customary for street vehicles. As a result, it is possible to use of the vehicles 1 on normal traffic routes as well as in conjunction with the inventive traffic system. Centrally between the wheels of the steered axle, the vehicles I have a steering and energy-supplying system 5, which can be swiveled in and out and has at least one tapping device 6, over which the vehicles can be supplied with electrical energy for the driving mechanism, as well as with control signals and, alternatively, with information and communications services. The steering and energy-supplying device 5 engages one of the guide rails 7, which are laid below the rolling plane of the wheels. In the example, which happens to be an elevated construction, the guide rail 7 is divided into two and open in the downward interaction. The vehicles 1 roll on driving bridges 8, the upper side of which is constructed so that rolling noise, arising from the rolling of the tires on the driving bridges, is broadcast upward in the direction of the wheel wells 2 lined with sound-absorbing material 3. For this purpose, the driving bridges 8 are bounded at the side by their raised beads 9. In the present example, the outer beads 9 are higher than the beads 9 facing the inside of the wheels. The driving bridges 8 rest over a vibration-damping intermediate layer 10 on the roadway substrate. In the case of the elevated railroad construction of FIG. 1, this roadway substrate consists of cross ties 11, which are carried at equal intervals on supports 12 at a distance above the ground. The supports 12 are anchored in the ground at such a depth, that their base 13 is below the frost line. In order to realize curve banking, the cross ties 11 are constructed in saw tooth fashion, so that the outer roadway is higher than the inner roadway.

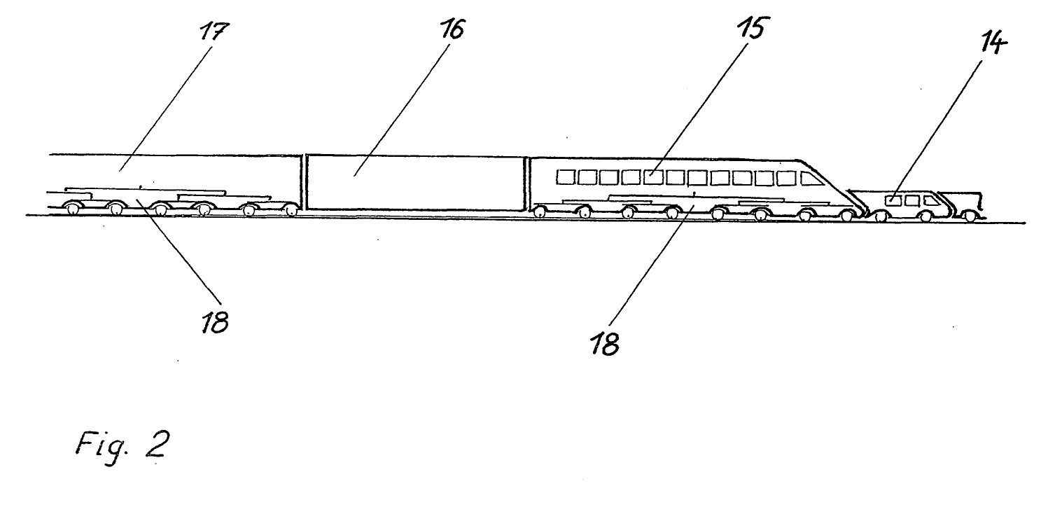

The second example, shown in FIG. 2, relates to a vehicle convoy, consisting of individual vehicles 14 and a public person-transporting vehicle 15, which has means, which are not shown, for hitching on a goods container 16. Since the goods container 16 does not have its own traveling mechanism, it is carried at its rear end by a truck 17. Trucks 17, as well as people-transporting vehicles 15 are constructed so that they may be guiding as well as tracking vehicles in a transport convoy with inserted goods container 16. The transport vehicles are configured so that the additional load, which is exerted on their traveling mechanisms 18 by the interposing of goods container 16, as indicated diagrammatically, is distributed uniformly over all axles.

All distinguishing features, given in the specification, the claims that follow and the drawing, may be essential to the invention individually as well as in any combination with one another.

### Fully Automatic Traffic System

### List of Reference Symbols

1. vehicle

2. wheel well

3. sound-absorbing material

4. tires

5. steering and energy supplying device

6. taps

7. guiding rail

8. driving bridge

9. bead

10. vibration-damping mounting

11. cross ties

12. supports

13. base

14. individual vehicle

15. people-transporting vehicle

16. goods container

17. truck

18. driving mechanism

1-15. (canceled)

16. An automatic traffic system, comprising:
individual vehicles, each including an independent driving system, a driver operable steering control and at least one energy take-off and guiding device;
a transmission route including a solid substrate forming bearing surfaces for respectively accommodating wheels of the individual vehicles, said solid substrate including roadway elements which are separately positionable, said transmission route having access points therealong, including entrances and exits via which the individual vehicles can access the transmission route;
an energy supplying and guiding system which is disposed between or adjacent to the bearing surfaces for at least providing driving energy, and which can be traversed above by any of the individual vehicles at least in a region of each of the entrances and exits; and
said energy take-off and guiding device being movable into operable connection with the energy supplying and guiding system while accessing the transmission route, and out of the operable range of the energy supplying and guiding system when exited from the transmission route.

17. An automatic traffic system according to claim 16, wherein the energy supplying and guiding system is disposed on the transmission route and protrudes an insignificant amount above a rolling plane of the vehicle wheels.

18. An automatic traffic system according to claim 16, wherein the bearing surfaces include a concave cross-sectional shape on a surface portion in which the vehicle wheels are guided.

19. An automatic traffic system according to claim 18, wherein the bearing surfaces include raised beads in edge regions thereof present over segments of the transmission route excluding said exits and entrances and any branches and crossings permitting traversal by others.

20. An automatic traffic system according to claim 19, wherein outer ones of the raised beads are higher that inner ones of said raised beads.

21. An automatic traffic system according to claim 19, wherein inner surfaces of the raised beads adjoining an outside of the vehicle wheels are provided with a sound-absorbing covering.

22. An automatic traffic system according to claim 16, wherein an underside of at least one of the individual vehicles is provided with a sound-absorbing covering.

23. An automatic traffic system according to claim 22, wherein said underside includes at least one wheel well.

24. An automatic traffic system according to claim 18, wherein an underside of at least one of the individual vehicles is provided with a sound-absorbing covering.

25. An automatic traffic system according to claim 24, wherein said underside includes a wheel well.

26. An automatic traffic system according to claim 16, wherein the bearing surfaces are provided with a wear resistant covering.

27. An automatic traffic system according to claim 26, wherein said wear resistant covering is exchangeable.

28. An automatic traffic system according to claim 16, further comprising cross ties resting on supports, said transmission route being mounted on said cross ties.

29. An automatic traffic system according to claim 1, wherein control signals for the individual vehicles are transmittable over the energy supplying and guiding system.

30. An automatic traffic system according to claim 16, wherein communication and information signals are transmittable over the energy supplying and guiding system.

31. An automatic traffic system according to claim 16, wherein the individual vehicles travel in convoys closely behind one another while traveling in the transmission route.

32. An automatic traffic system according to claim 16, further comprising a system for controlling a particular interval between the individual vehicles while traveling in the transmission route.

33. An automatic traffic system according to claim 31, further comprising goods containers which are disposable between two of said individual vehicles to form a goods-transporting convoy.

34. An automatic traffic system according to claim 32, further comprising goods containers which are disposable between two of said individual vehicles to form a goods-transporting convoy.
